(19) United States
(12) Patent Application Publication
(10) Pub. No.: US 2003/0126953 A1
(43) Pub. Date: Jul. 10, 2003

(54) Cork extractor system

(76) Inventor: Robert G. Kushner, Hong Kong (HK)

Correspondence Address: GREENBERG TRAURIG, LLP, 885 THIRD AVENUE, 21st FLOOR, New York, NY, 10022, US

(21) Appl. No.: 10/040,650

(22) Filed: Jan. 7, 2002

(51) Int. Cl. B67B 7/00

(52) U.S. Cl. 81/3.45

(57) ABSTRACT

A corkscrew assembly capable of use with a lever-type cork extractor and comprising a bearing-rivet combination fixedly attached to a helical component forming a corkscrew head. A spacer is mounted on the bearing of the corkscrew head and both the spacer and the corkscrew head are disposed in the cavity of a cup-shaped nut forming the corkscrew assembly of the present invention. The corkscrew assembly is detachably mounted to a component of a cork extractor body and thus removably coupled to a cork extractor. The mounted corkscrew is caused to simultaneously move longitudinally and rotate by the cork extractor body. Due to the presence of the spacer, the corkscrew assembly rotates in a smooth and unhampered fashion about a relatively fixed axis of rotation. The cup-shaped nut protects the bearing from debris and liquids. The corkscrew assembly or any portion thereof can be replaced when damaged.

### BACKGROUND OF THE INVENTION

1. Field of the Invention

The present invention relates to a cork extractor system incorporating a corkscrew assembly for use in lever-type cork extracting devices.

2. Description of the Related Art

Cork extracting devices have been designed with mechanisms whereby a corkscrew is rotatably driven into a cork to improve ease of insertion and depth of insertion of the corkscrew into a cork frictionally disposed in the neck of a bottle and proximate the opening of the bottle. In some cork extractor designs, the corkscrew uses some type of bearing assembly that enables it to rotate as it punctures and penetrates the cork. Although the bearing assembly may be somewhat protected from external debris and liquids, repeated usage of the cork extracting device will inevitably lead to unwanted debris lodging into the bearing assembly. Furthermore, users of cork extracting devices may tend to wash these devices with various liquids, soaps and/or detergents. The various parts of the bearing assembly may be constructed from metals or metallic alloys that rust over time due to extended exposure to liquids or a moist or corrosive environment. Thus, washing the corkscrew device or somehow exposing the corkscrew device to a damp or moist environment may lead to rusting of some or all of the various parts of the bearing assembly.

The rusting of the parts of the assembly and the lodging of unwanted debris may not be noticed even by a careful and observant user. Moreover, even if the problem of debris and rust is noticed, it is very difficult to clean the bearing assembly, mainly due to the relatively small size of its various parts intricately engaged with one another. It is well known that a bearing assembly's operation is based upon the relatively smooth relatively friction-free motion between surfaces of its components. The surfaces may be metallic, non-metallic (e.g., polymer or plastic materials) or the surfaces made from any well known combination of metallic and non-metallic materials. In many designs, a lubricant is often added to promote the smooth frictional motion between the various surfaces of the bearing. To maintain the proper operation of a corkscrew device having a bearing assembly, proper care of such device is necessary which includes occasional application of a lubricant to the bearing assembly. Even when the device is properly maintained, the bearing assembly may eventually malfunction due to wear and tear and/or lack of sufficient lubricant on the surfaces of the various parts that constitute the bearing. A properly rotating lever-type corkscrew rotates in relatively smooth and unhampered manner. Also, a properly rotating lever-type corkscrew rotates about a relatively fixed (i.e., substantially non-varying) longitudinal axis. Without a properly rotating corkscrew, the cork extractor may not be able to fully penetrate a cork or may actually push the cork into the bottle. Furthermore, without relatively extreme low friction during rotation of the helical screw, the torque required to remove the cork from the helical screw is greatly increased. The bearing assembly reduces the torque required to remove the cork and it prevents the extracted cork from remaining stuck onto the helical screw requiring manual removal of the cork.

The lack of such a smooth rotation may also be due to the design of the particular mechanism associated with a cork extractor. During operation of a lever-type cork extractor, the corkscrew is moved longitudinally (i.e., up and down) with respect to the cork extractor body. Simultaneously, the corkscrew moves longitudinally and rotates with the use of any well known mechanism or arrangement. The mechanism which causes the corkscrew to move longitudinally may, in some instances, somewhat degrade the corkscrew's rotation. Specifically, the rotating corkscrew may have not have a fixed axis of rotation as it moves longitudinally due to some axial or lateral movement by the longitudinally moving and rotating corkscrew. Axial movement, which is movement in a direction substantially perpendicular to the axis of rotation, results in an non-smooth rotation of the corkscrew which may render the cork extractor partially or totally inoperative.

What is therefore needed is a lever-type cork extractor having a properly rotating corkscrew whereby such cork extractor is operable even after having been exposed to unwanted liquids and debris.

### SUMMARY OF THE INVENTION

The present invention provides a corkscrew assembly removably coupled to a cork extractor body. The corkscrew assembly comprises a helical component having a head portion and a body portion. A rivet rotatably coupled to or integral with a bearing forms a bearing-rivet combination that is fixedly attached to the head portion of the helical component. The corkscrew assembly further comprises a spacer mounted on the bearing-rivet combination and a cup-shaped nut formed with a cavity defined by inner surfaces. The spacer mounted on the bearing-rivet combination and which is fixedly attached to the head portion of the helical component are together disposed within the nut's cavity such that the spacer makes direct contact with the inner surfaces of the cavity. The corkscrew assembly is thus able to properly rotate (i.e., rotate about a relatively fixed axis of rotation) with respect to the cup-shaped nut. The corkscrew assembly is detachably mounted to a component of the cork extractor body allowing the cork extractor to move the corkscrew assembly longitudinally with respect to the cork extractor body and simultaneously rotate the corkscrew assembly about a relatively fixed axis of rotation. The cup-shaped nut provides protection to the bearing of the corkscrew assembly from debris and liquids. The rotation of the corkscrew is proper in that it rotates about a relatively fixed axis of rotation resulting in a relatively smooth and unhampered rotation of the corkscrew assembly. Over time the corkscrew assembly or any portion thereof may become damaged (e.g., rusted helical component, dull helical component, warped helical component, rusted bearing) due to wear and tear or exposure to moisture. The corkscrew assembly or any portion thereof can be removed from the cork extractor and replaced with an equivalent portion or assembly.

### BRIEF DESCRIPTION OF THE DRAWINGS

FIG. 1 depicts an exploded perspective view of the of the corkscrew assembly of the present invention;

FIG. 2 shows a perspective view of the rotatable corkscrew portion of the corkscrew assembly of the present invention;

FIG. 3 is a side view of FIG. 1;

FIG. 4 is an exploded perspective view of the corkscrew assembly of the present invention and various components of a cork extractor body;

FIG. 5 shows a side view of the corkscrew assembly of the present invention detachably and removably coupled to components of an extractor body;

FIG. 6 is a side view of a cork extractor having the corkscrew assembly of the present invention; and

FIG. 7 is a top view of FIG. 6.

### DETAILED DESCRIPTION

The present invention provides a corkscrew assembly removably coupled to a cork extractor body. Please note that while the terms “cork extractor” and “corkscrew” are sometimes used synonymously by others, as my own lexicographer I am choosing to use the term “corkscrew assembly” as an assembly component cooperatively disposed within or as part of what I am referring to herein as a “cork extractor” having a “cork extractor body”.

The corkscrew assembly according to a preferred embodiment of the present invention comprises a helical component having a head portion and a body portion. A rivet rotatably coupled to a bearing forms a bearing-rivet combination that is fixedly attached to the head portion of the helical component. The corkscrew assembly further comprises a spacer mounted on the bearing-rivet combination and a cup shaped nut having a cavity defined by inner surfaces. The spacer mounted on the bearing-rivet combination and which is fixedly attached to the head portion of the helical component are together disposed within the nut's cavity such that the spacer makes direct contact with the inner surfaces of the cavity. The corkscrew assembly is thus able to properly rotate (i.e., rotate about a relatively fixed axis of rotation) with respect to the cup-shaped nut. The corkscrew assembly is detachably mounted to a component of the cork extractor body, allowing the cork extractor to move the corkscrew assembly longitudinally with respect to the cork extractor body and simultaneously to rotate the corkscrew assembly about a relatively fixed axis of rotation. The cup-shaped nut provides protection to the bearing of the corkscrew assembly from debris and liquids. The rotation of the corkscrew is proper in that it rotates about a relatively fixed axis of rotation resulting in a relatively smooth and unhampered rotation of the corkscrew assembly. Over time the corkscrew assembly or any portion thereof may become damaged (e.g., rusted helical component, dull helical component, warped helical component, rusted bearing) due to wear and tear or exposure to moisture. The corkscrew assembly or any portion thereof can be removed from the cork extractor and replaced with an equivalent portion or assembly. The bearing assembly allows for removal of corks of greater density than natural cork, such as synthetic corks which are gaining wider use in bottles. The current corkscrews are often damaged when used to remove synthetic corks. The current bearing assembly was specifically designed to address the increased torque requirements of synthetic corks.

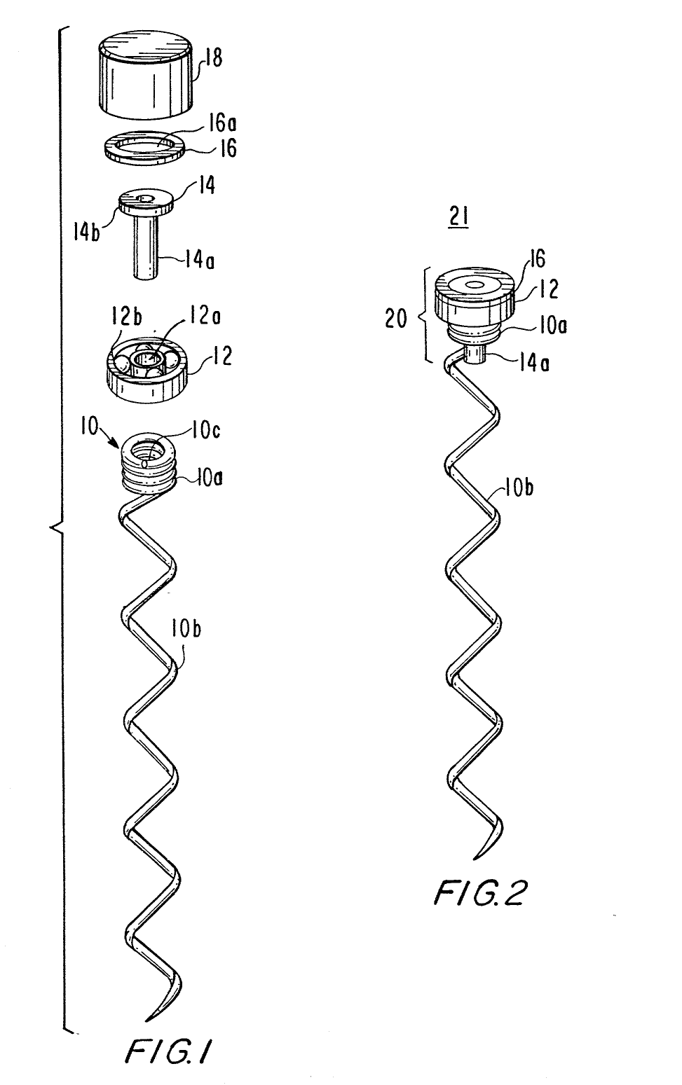

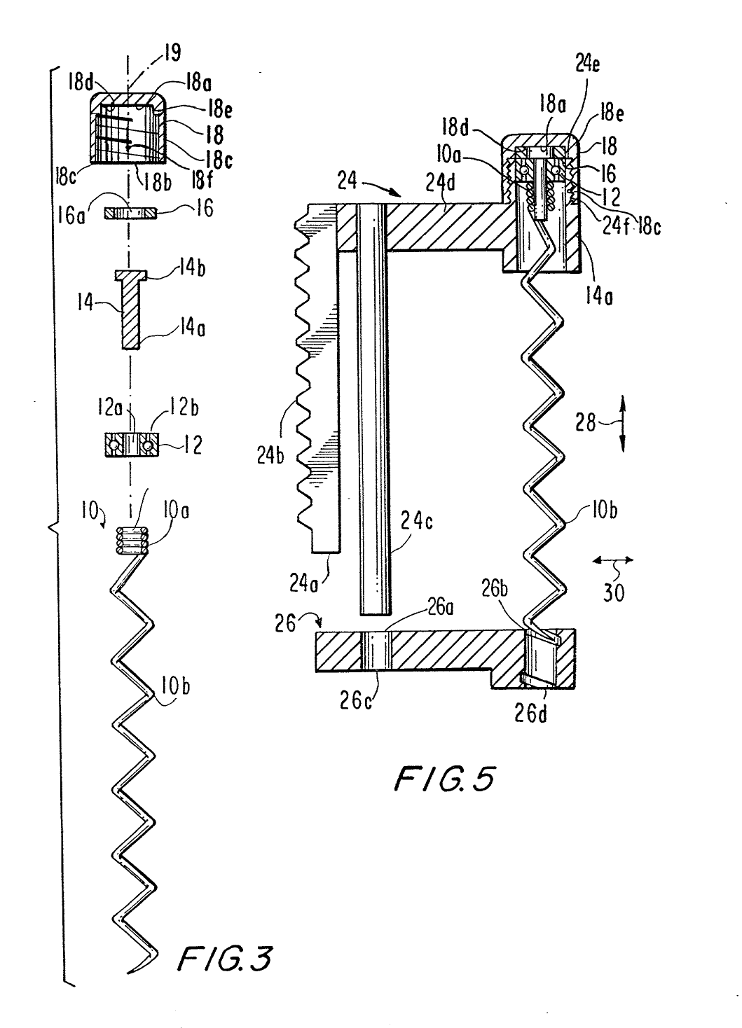

Referring to FIG. 1, there is shown the corkscrew assembly of the present invention comprising cup-shaped nut 18, spacer 16, bearing 12 and helical component 10 having a head portion 10a and a body portion 10b. Helical component 10 is also referred to as a worm screw. Head portion 10a has an opening and forms a passageway 10c. Rivet 14 is rotatably coupled to bearing 12 through bearing opening 12a forming a bearing-rivet combination 12, 14 in which annular portion 12b rotates about rivet 14. The bearing-rivet combination is fixedly attached to helical component 10 by inserting the lower portion 14a of rivet 14 through passageway 10c. The attachment can be achieved in any one of several well known fashion such as adhering lower portion 14a of rivet 14 to head portion 10a of the helical component with some type of cement or adherent agent. Also, lower portion 14a can be constructed with threads or axial projections (not shown) to allow head portion 10a to threadingly engage rivet 14. A spacer 16 having spacer opening 16a is placed or mounted on top of the bearing-rivet combination (see FIG. 2) that is fixedly attached to helical component 10. Although shown as substantially circular in shape, other shapes (square, hexagonal or any polygonal shape) can be used for spacer 16. Spacer 16 is preferably dimensioned such that its outer periphery is flush with the outer periphery of bearing 12 and its inner periphery frictionally engages the outer periphery of rivet head 14b; spacer 16 is also flush with rivet head 14b. The helical component, bearing-rivet combination and spacer assembly is shown in FIG. 2 and is hereinafter referred to as “the rotatable corkscrew” 21. The bearing-rivet combination 12, 14, helical component head portion 10a and spacer 16—viz., rotatable corkscrew head 20—are disposed in cup-shaped nut 18 thus forming the corkscrew assembly of the present invention with spacer 16 making direct contact with inner surfaces of cup-shaped nut 18 allowing for a relatively smooth and unhampered rotational motion between the rotatable corkscrew and cup-shaped nut 18. Also, when disposed in cup-shaped nut 18, spacer 16 of rotatable corkscrew head 20 will reduce any lateral or axial movement of the rotatable corkscrew relative to cup-shaped nut 18. Further, the rotatable corkscrew 21 or other parts of the corkscrew assembly may become damaged (e.g., warped or bent worm screw, rusted bearing or rusted worm screw). The detachable coupling of cup-shaped nut 18 to a component of an extractor body allows the corkscrew assembly or any portion thereof to be removably coupled to a cork extractor. Thus, when damaged, the corkscrew assembly or any portion thereof can be easily replaced.

Referring to FIG. 3, there is shown a side view of the corkscrew assembly of FIG. 1. Cup-shaped nut 18 has inner surfaces 18a, 18d, 18e and 18c. Cup shaped nut 18 is further formed with cavity 18c defined by the inner surfaces and opening 18b. Inner surfaces 18c form a thread used to detachably couple the corkscrew assembly of the present invention to a component of a cork extractor body. The axis of rotation of the rotatable corkscrew assembly is shown as reference 19.

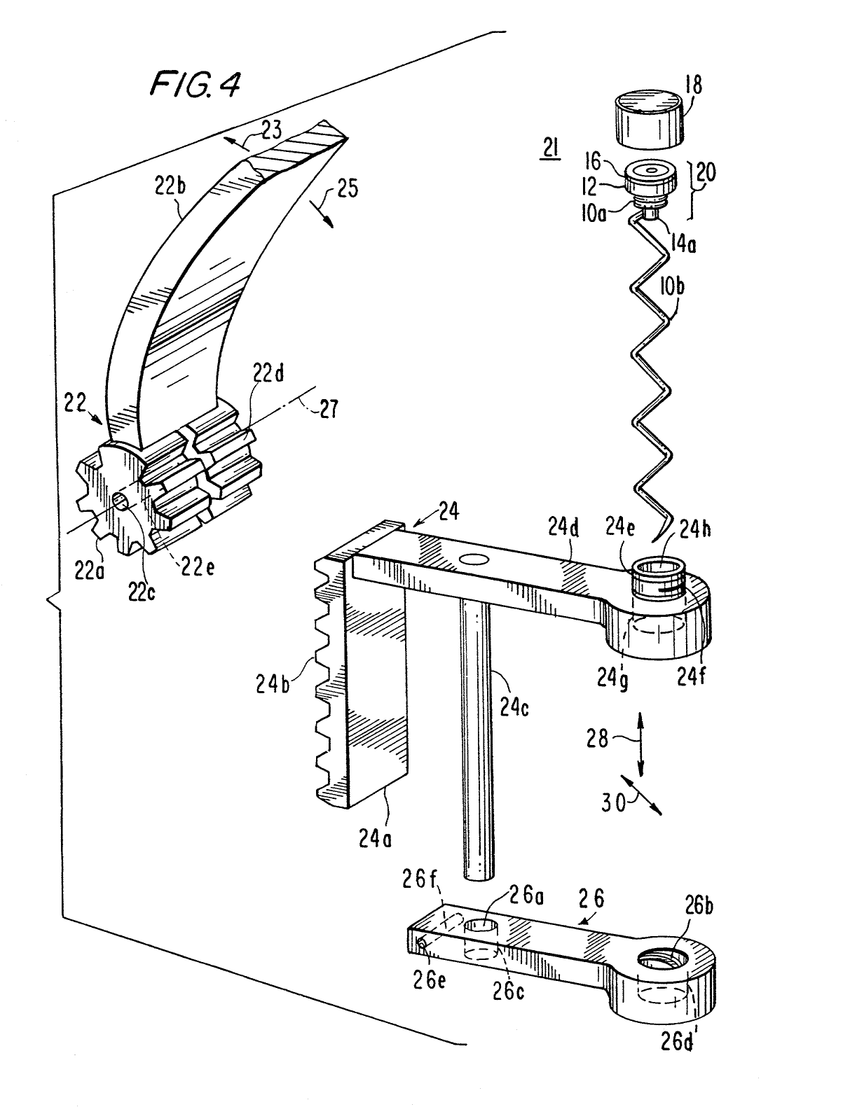

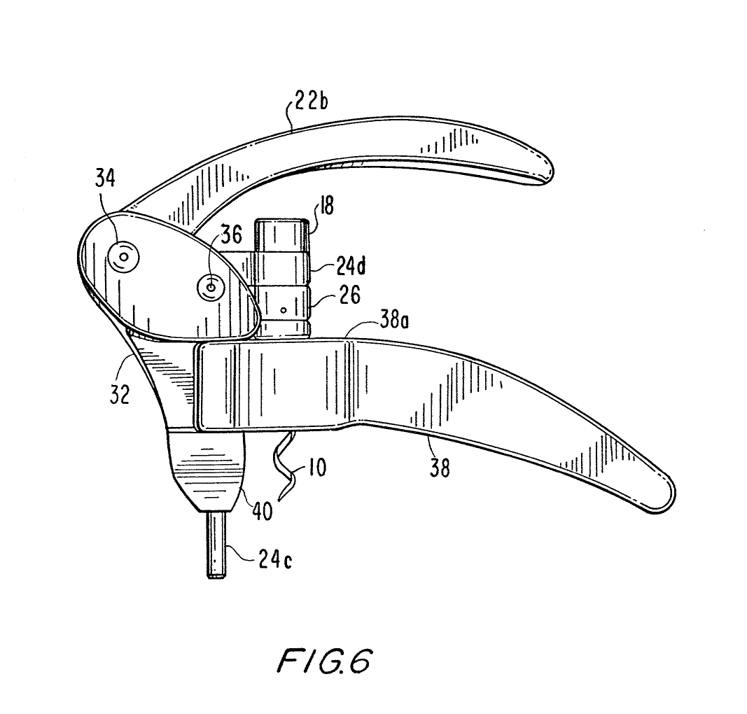

Referring now to FIG. 4, there is shown the corkscrew assembly of the present invention along with some components of a cork extractor body. The components shown are lever 22, gear assembly 24 and guide member 26. Lever 22 has lever head 22a, lever handle 22b (a portion of which is shown) and engagement portion 22d. Gear assembly 24 comprises gear rack 24a having gear teeth 24b, rod 24c, arm 24d, nipple 24e having threads 24f and guide member 26. Guide member 26 has openings 26a and 26b for passageways 26c and 26d (shown in dashed lines). Passageway 26d is configured to receive helical component body portion 10b such that rotatable corkscrew 21 rotates as corkscrew assembly moves longitudinally in the directions shown by arrow 28. Nipple 24e has opening 24h that extends through arm 24d to form passageway 24g (shown in dashed lines). When lever 22 is positioned such that engagement portion 22d of lever head 22a engages teeth 24b of gear rack 24a, a rotational movement of lever 22b about axis 27 in the directions shown by arrows 23 or 25 causes gear assembly 24 to move longitudinally in the directions shown by arrow 28. Gear member 24 is slidably attached to a cork extractor housing (not shown) and moves longitudinally relative to guide member 26 which remains stationary. Guide member 26 is fixedly attached to the cork extractor housing. The corkscrew assembly of the present invention is detachably mounted onto gear assembly 24 through a threading engagement between threads 24f and 18c of nipple 24e and cup-shaped nut 18 respectively. In particular, rotatable corkscrew 21 is inserted through opening 24h of gear assembly 24 such that a part of lower portion 10b of helical component 10 is positioned within passageway 26d (see FIG. 5). With rotatable corkscrew head 20 thus positioned on top of nipple 24e, cup-shaped nut 18 is threadingly engaged to nipple 24e. The corkscrew assembly of the present invention is thus removably coupled to a cork extractor by using cup-shaped nut 18 to detachably mount the assembly to a component of the cork extractor body.

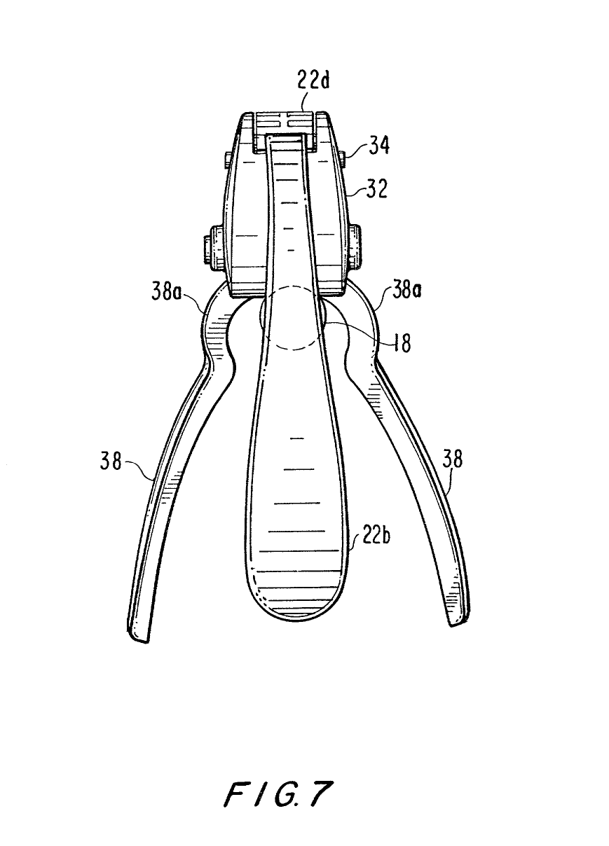

Referring to FIG. 5, there is shown a side view of the cork assembly of the present invention detachably mounted to gear assembly 24 of a cork extractor body. Spacer 16 reduces any lateral or axial motion (in the direction shown by arrow 30) by the corkscrew assembly of the present invention as it is moved longitudinally and simultaneously caused to rotate by a cork extractor body. It should be noted that arrows and 28 and 30 are substantially perpendicular with respect to each other. As gear assembly 24 is caused to move longitudinally, rod 24c is guided by passageway 26c which is further extended through the cork extractor body (not shown). Also, lower portion 10b of helical component 10 is guided by passageway 26d which also causes the corkscrew assembly to rotate in a smooth and unhampered fashion with reduced lateral motion due to spacer 16. Gear assembly 24, with the corkscrew assembly of the present invention detachably mounted thereto, is slidably attached to a housing component 32 (not shown; see FIGS. 6 and 7) of the cork extractor.

Referring back to FIG. 4, lever 22 is rotatably attached to housing component 32 with a pin or rivet 34 (not shown; see FIGS. 6 and 7) inserted through opening 22c that extends forming passageway 22e (shown in dashed lines) of lever head 22a. Guide member 26 is fixedly attached to extractor housing 32 with a pin or rivet 36 (not shown; see FIGS. 6 and 7) inserted through opening 26e that extends through guide member 26 as shown to form passageway 26f (shown in dashed lines). Housing component 32, pins 34 and 35 and other cork extractor body components are shown in FIGS. 5 and 6.

Referring now to FIGS. 6 and 7, there are shown a side view and a top view of a cork extractor including the cork assembly of the present invention removably mounted thereto. Referring to FIG. 5, the cork extractor has housing component 32 to which handles 38 are rotationally attached. Cork extractor housing 32 further has integrated extension 40 having a passageway (not shown) aligned with passageway 26c through which rod 24c traverses as gear assembly 24 and the cork assembly of the present invention are caused to move longitudinally. FIG. 7 shows a top view of the cork extractor of FIG. 6. Handles 38 have curved portions 38a for gripping the neck of a bottle.

I claim:

1. A corkscrew assembly comprising:
a helical component having a head portion and a body portion;
a rivet rotatably coupled to a bearing forming a bearing-rivet combination that is fixedly attached to the head portion of the helical component;
a spacer mounted on the bearing; and
a cup-shaped nut having cavity within which the spacer, bearing-rivet combination and helical component head portion are disposed where the spacer makes direct contact with inner surfaces that define the cavity.

2. The corkscrew assembly of claim 1 where the cup-shaped nut is used to detachably mount the corkscrew assembly to a component of a cork extractor body thus removably coupling the corkscrew assembly to the cork extractor.

3. The corkscrew assembly of claim 1 where the spacer is shaped as a polygon.

4. Apparatus for extracting a cork from a bottle, comprising, in combination:
a extractor body,
a carrier supported by said body capable of reciprocating movement with respect to said body, and
a corkscrew assembly supported by said body, said corkscrew assembly comprising:
a helical component having a head portion and a body portion;
a rivet rotatably coupled to a bearing forming a bearing-rivet combination that is fixedly attached to the head portion of the helical component;
a spacer mounted on the bearing; and
a cup-shaped nut having cavity within which the spacer, bearing-rivet combination and helical component head portion are disposed where the spacer makes direct contact with inner surfaces that define the cavity.
